(19) United States
(12) Patent Application Publication
(10) Pub. No.: US 2017/0352130 A1
(43) Pub. Date: Dec. 7, 2017

(54) DISPLAY APPARATUS DYNAMICALLY ADJUSTING DISPLAY RESOLUTION AND CONTROL METHOD THEREOF

(71) Applicant: MEDIATEK INC., Hsin-Chu (TW)

(72) Inventors: Chun-Hsiung Hu, Hsinchu City (TW); Shih-Chieh Huang, New Taipei City (TW); Yu-Cheng Chang, Chiayi City (TW); Jen-Chieh Lo, Nantou County (TW)

(21) Appl. No.: 15/173,709

(22) Filed: Jun. 5, 2016

(51) Int. Cl. G06T 3/40; G06F 3/01

(52) U.S. Cl. CPC G06T 3/40; G06F 3/017

(57) ABSTRACT

A display apparatus is provided. The display apparatus includes a detector and a controller. The detector is arranged for detecting motion of the display apparatus to identify an activity of a user of the display apparatus, and accordingly generating an identification result. The controller is coupled to the detector, and is arranged for determining a display resolution of the display apparatus according to the identification result.

### BACKGROUND

The disclosed embodiments of the present invention relate to display resolution control, and more particularly, to a display apparatus referring to human activity to dynamically adjust a display resolution and a related control method thereof.

In order to improve a user's viewing experience, manufacturers devote efforts to increasing a pixel density of a display (measured in pixels per inch (PPI)) of an electronic apparatus such as a battery-powered device (e.g. a mobile phone or a tablet computer). For example, a 5.5-inch mobile display with a 4K ultra-high definition (UHD) (3840λ2160) has a display density of up to 806 PPI. However, power consumption of an electronic apparatus increases due to an increase in display density, resulting in shortened battery life. The user has to charge the electronic apparatus frequently.

Thus, there is a need for a novel display mechanism to not only provide an enjoyable user's viewing experience but also maintain long battery life.

### SUMMARY

In accordance with exemplary embodiments of the present invention, a display apparatus referring to human activity to dynamically adjust a display resolution, and a related control method thereof are proposed to solve the above-mentioned problems.

According to an embodiment of the present invention, an exemplary display apparatus is disclosed. The exemplary display apparatus comprises a detector and a controller. The detector is arranged for detecting motion of the display apparatus to identify an activity of a user of the display apparatus, and accordingly generating an identification result. The controller is coupled to the detector, and is arranged for determining a display resolution of the display apparatus according to the identification result.

According to an embodiment of the present invention, an exemplary control method of a display apparatus is disclosed. The exemplary control method comprises the following steps: detecting motion of the display apparatus to identify an activity of a user of the display apparatus, and accordingly generating an identification result; and determining a display resolution of the display apparatus according to the identification result.

By dynamically adjusting a display resolution according to different user activities or usage scenarios, the proposed display mechanism may not only reduce power consumption but also maintain good user's viewing experience.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart of an exemplary control method of a display apparatus according to an embodiment of the present invention.

FIG. 2 is a block diagram illustrating an exemplary display apparatus according to an embodiment of the present invention.

FIG. 3 is an implementation of the detector shown in FIG. 2.

FIG. 4 is an implementation of the display apparatus shown in FIG. 2.

FIG. 5 is a diagram illustrating exemplary display resolutions of the display screen corresponding to different activities of a user of the display apparatus shown in FIG. 4 according to an embodiment of the present invention.

FIG. 6 is a diagram illustrating the display apparatus shown in FIG. 2 connecting an external display screen according to an embodiment of the present invention.

FIG. 7 is a flow chart of an exemplary control method of a display apparatus according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “coupled” is intended to mean either an indirect or direct electrical connection. Accordingly, if one device is electrically connected to another device, that connection may be through a direct electrical connection, or through an indirect electrical connection via other devices and connections.

The proposed display mechanism may dynamically adjust a display resolution according to different user activities or usage scenarios (e.g. resting, walking and running) while maintaining a good user's viewing experience, thereby reducing power consumption of a display apparatus. By way of example but not limitation, when a user is walking and watching a video played on a portable electronic apparatus (e.g. a display apparatus) held by the user, the eye's perception of display resolution is reduced as compared to when the user is sitting on a chair and watching the video. Hence, when the user is walking and watching the video played on the display apparatus held by the user, the proposed display apparatus may dynamically decrease a display resolution of the display apparatus in response to an activity of the user (i.e. walking) to thereby reduce power consumption, wherein the user may still have an enjoyable viewing experience. Additionally, the proposed display mechanism may detect motion of a display apparatus to identify an activity of a user of the display apparatus, and accordingly dynamically adjust a display resolution of the display apparatus to reduce power consumption. Further description is provided below.

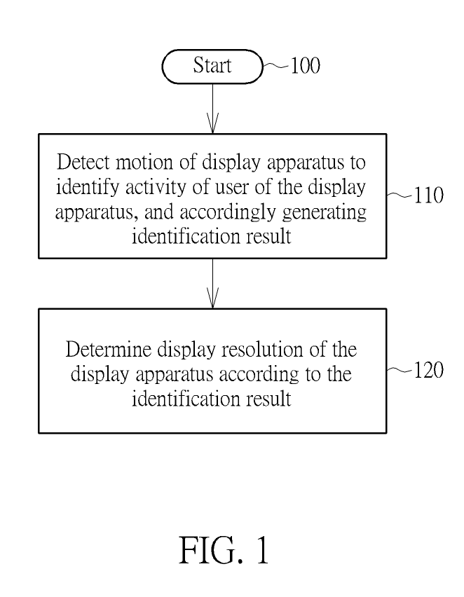

Please refer to FIG. 1, which is a flow chart of an exemplary control method of a display apparatus according to an embodiment of the present invention. The display apparatus may be any electronic apparatus capable of displaying images such as a battery-powered device (e.g. a mobile phone or a tablet computer). The exemplary control method shown in FIG. 1 may be summarized below.

Step 100: Start.

Step 110: Detect motion of the display apparatus to identify an activity of a user of the display apparatus, and accordingly generate an identification result.

Step 120: Determine a display resolution of the display apparatus according to the identification result.

In step 110, the activity of the user may be identified according to the detected motion of the display apparatus, including position information, translation information and/or rotation information, wherein a type of the activity of the user may be, by way of example but not limitation, resting (e.g. a still or almost still state), walking, running, cycling or commuting (e.g. standing or sitting in a public transport vehicle).

In step 120, the display resolution may meet the human eye's ability to perceive resolution under a condition where the user performs the activity. By way of example but not limitation, when the identification result indicates that the activity of the user is a first type user activity (e.g. a sedentary activity or a low-motion activity), the display resolution may be set to a first resolution; when the identification result indicates that the activity of the user is a second type user activity different from the first type user activity (e.g. an energetic activity or a high-motion activity), the display resolution may be set to a second resolution different from the first resolution.

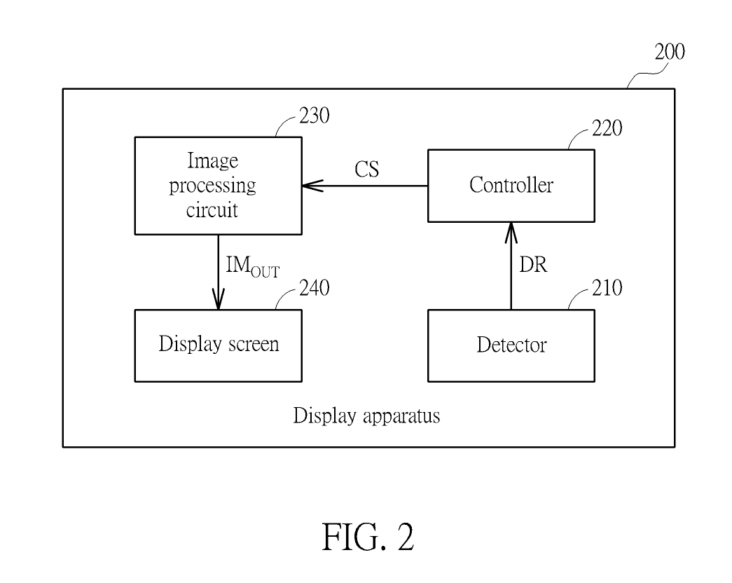

FIG. 2 is a block diagram illustrating an exemplary display apparatus according to an embodiment of the present invention, wherein the display apparatus 200 may employ the control method shown in FIG. 1 to dynamically adjust a display resolution. In this embodiment, the display apparatus 200 may include, but is not limited to, a detector 210, a controller 220, an image processing circuit 230 and a display screen 240. The detector 210 may be used for detecting motion of the display apparatus 200 to identify an activity of a user of the display apparatus 200, and accordingly generating an identification result DR. The controller 220 is coupled to the detector 210, and is arranged for determining a display resolution of the display apparatus 200 according to the identification result DR. The image processing circuit 230 is coupled to the controller 220, and is arranged for generating an image output IM_{OUT} according to the display resolution. For example, the controller 220 may generate a control signal CS to thereby enable the image processing circuit 230 to generate the image output IM_{OUT} according to the display resolution.

The display screen 240 is coupled to the image processing circuit 230, and is arranged for displaying the image output IM_{OUT}. When the identification result DR indicates that the activity of the user is a first type user activity, the image processing circuit 230 may generate the image output IM_{OUT} according to a first resolution, and the display screen 240 may display the image output IM_{OUT} at the first resolution; when the identification result DR indicates that the activity of the user is a second type user activity different from the first type user activity, the image processing circuit 230 may generate the image output IM_{OUT} according to a second resolution different from the first resolution, and the display screen 240 may display the image output IM_{OUT} at the second resolution.

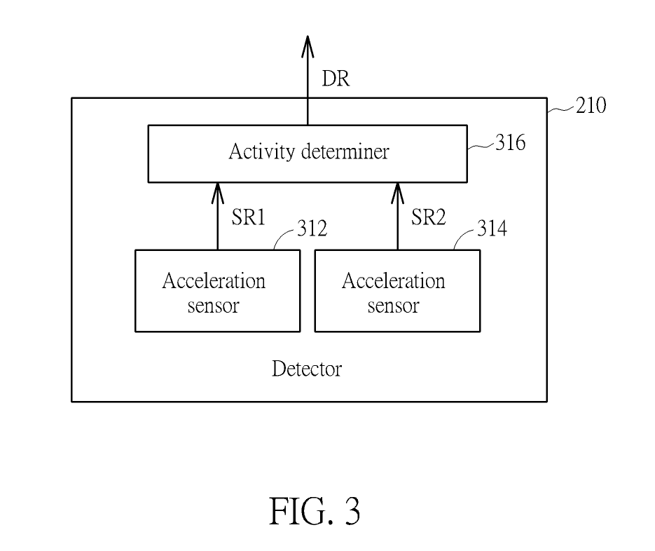

In one implementation, the detector 210 may utilize at least one acceleration sensor to detect the motion of the display apparatus 200 to identify the activity of the user. Please refer to FIG. 3 together with FIG. 2. FIG. 3 is an implementation of the detector 210 shown in FIG. 2. In the implementation shown in FIG. 3, the detector 210 may include an acceleration sensor 312, an acceleration sensor 314 and an activity determiner 316. The acceleration sensor 312 and the acceleration sensor 314 may detect the motion of the display apparatus 200 to generate a sensor result SR1 and a sensor result SR2 respectively. The activity determiner 316, coupled to the acceleration sensors 312 and 314, may identify the activity of the user according to the sensor results SR1 and SR2.

By way of example but not limitation, the acceleration sensor 312 may be implemented by a linear acceleration sensor (e.g. an accelerometer (G-sensor)), and/or the acceleration sensor 314 may be implemented by an angular acceleration sensor (e.g. an orientation sensor (O-sensor) or a gyroscope sensor (gyro-sensor)). Hence, the detector 210 may detect linear motion information and/or angular motion information of the display apparatus 200, and the activity determiner 316 may identify the activity of the user according to the detected linear motion information and/or angular motion information. As a person skilled in the art should understand the operation of the activity determiner 316 which identifies the activity of the user according to the sensor result(s) of the acceleration sensor(s), further description is omitted here for brevity.

It should be noted that the structure of the detector shown in FIG. 3 (e.g. types of acceleration sensors, and the number of acceleration sensors) is for illustrative purposes only, and is not meant to be a limitation of the present invention. For example, the detector 210 may utilize at least one acceleration sensor (one or more acceleration sensors) to detect the motion of the display apparatus 200, and the activity determiner 316 may identify the activity of the user according to sensor result(s) of the at least one acceleration sensor, wherein the at least one acceleration sensor may include at least one of a linear acceleration sensor and an angular acceleration sensor. Additionally, in a case where the detector 210 utilizes at least one linear acceleration sensor and at least one angular acceleration sensor, the detector 210 may use algorithms to calculate respective sensor results of the at least one linear acceleration sensor and the at least one angular acceleration sensor, and may be implemented as a combined sensor such as a gravity sensor (GV-sensor), a linear acceleration sensor (LA-sensor) and/or a rotation vector sensor (RV-sensor). In another example, the detector 210 may further include other types of sensors, such as a global positioning system (GPS) sensor, an ambient light sensor and/or a proximity sensor, used for detecting the motion of the display apparatus 200 and accordingly generating corresponding sensor result (s). The activity determiner 316 may identify the activity of the user according to one or more sensor results generated by the detector 210.

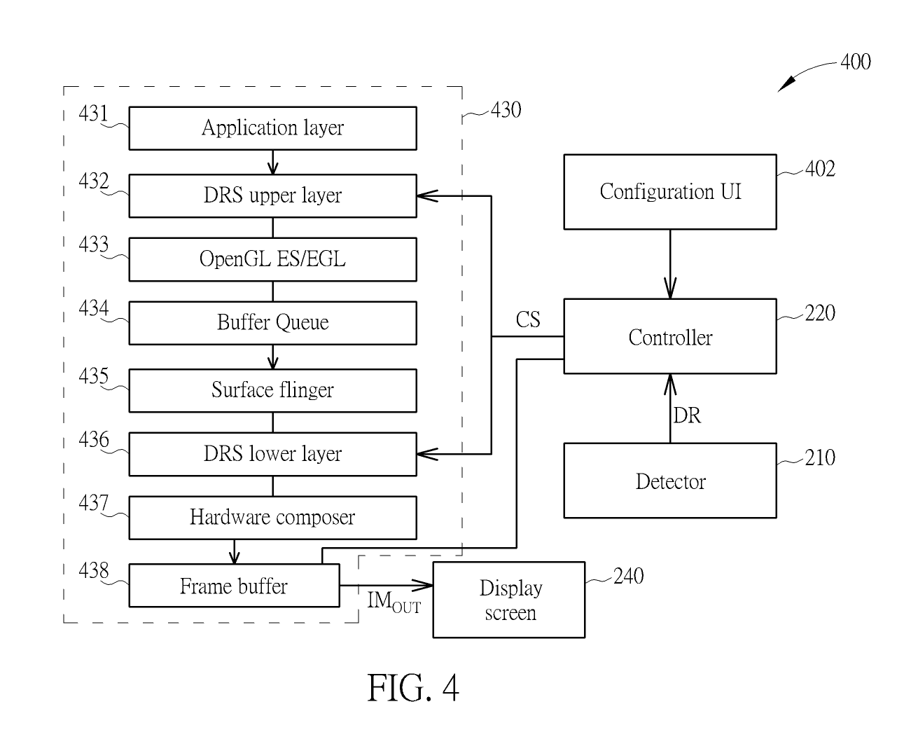

Further, after the detector 210 identifies the activity of the user to generate the identification result DR, the controller 220 may refer to the identification result DR to control the image processing circuit 230 to adjust the display resolution. Please refer to FIG. 4, which is an implementation of the display apparatus 200 shown in FIG. 2. In this implementation, the display apparatus 400 may include, but is not limited to, the detector 210, the controller 220 and the display screen 240 shown in FIG. 2, a configuration user interface (UI) 402 and an image processing circuit 430, wherein the image processing circuit 230 shown in FIG. 2 may be implemented by the image processing circuit 430.

For illustrative purposes, the proposed display mechanism (or a dynamic resolution scaling mechanism) is described with reference to the image processing circuit 430 employing Android graphics architecture. However, this is not meant to be a limitation of the present invention. It is possible to utilize other graphics architecture to perform dynamic resolution scaling. In this embodiment, the image processing circuit 430 may include, but is not limited to, an application layer 431, a dynamic resolution scaling (DRS) upper layer 432, an OpenGL ES/EGL 433, a buffer queue 434, a surface flinger 435, a DRS lower layer 436, a hardware composer 437 and a frame buffer 438. The application layer 431 may call an application programming interface (API) of the OpenGL ES/EGL 433 to use a graphic processing unit (GPU) (not shown in FIG. 4) to perform graphics processing, and a resulting processing result may be stored in a graphics buffer within the buffer queue 434 (not shown in FIG. 4). The surface flinger 435 may coordinate graphics buffers invisible layers (e.g. the graphic buffers within the buffer queue 434), and ask the hardware composer 437 to composite all visible layers together to thereby generate graphics data to the frame buffer 438.

In one embodiment, after determining the display resolution of the display apparatus 200 according to the identification result DR, the controller 220 may generate the control signal CS to control the DRS upper layer 432 to intercept function calls of the OpenGL ES/EGL 433, ensuring that graphics rendering is performed with a proper display resolution. Additionally, before the hardware composer 437 composite all the visible layers together, the DRS lower layer 436 may intercept function calls passed to the hardware composer 437, ensuring that the composition is done with a proper display resolution. For example, the DRS upper layer 432 may refer to the control signal CS to perform resolution downscaling, and the DRS lower layer 436 may refer to the control signal CS to perform resolution upscaling. As a person skilled in the art should understand the operation of each element within the image processing circuit 430, further description is omitted here for brevity.

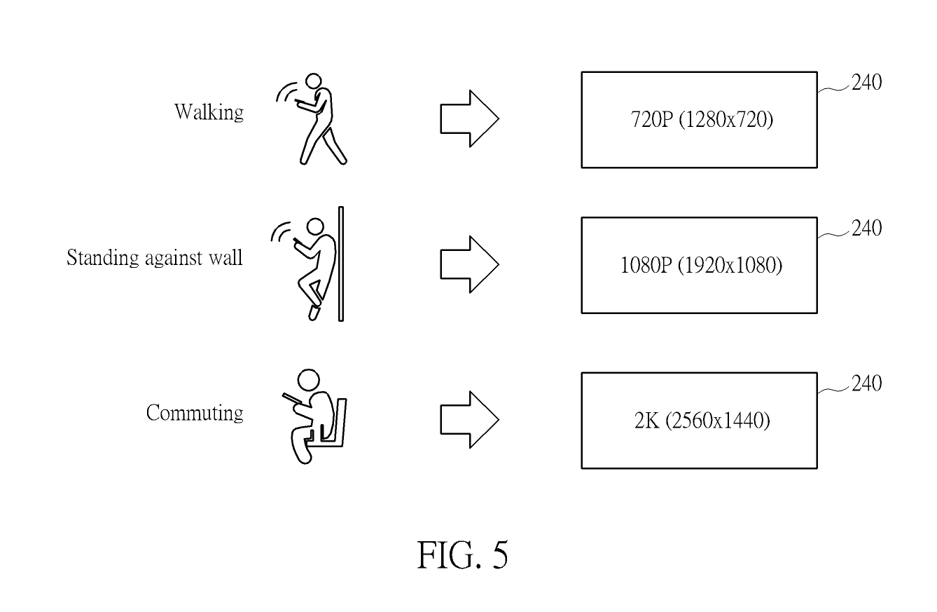

Based on the aforementioned resolution downscaling and resolution upscaling, the display apparatus 400 may dynamically adjust the display resolution of the display screen 240. Please refer to FIG. 5, which is a diagram illustrating exemplary display resolutions of the display screen 240 corresponding to different activities of a user of the display apparatus 400 shown in FIG. 4 according to an embodiment of the present invention. In this embodiment, the activities of the user may include walking, standing against a wall, and sitting on a seat in a public transport vehicle while commuting. It should be noted that, when the user of the display apparatus 400 is walking, the eye's perception of display resolution reduces accordingly. This means that the user may have a satisfied viewing experience even if the display apparatus 400 does not provide a relatively high display resolution. Hence, when the user is walking, the display resolution of the display screen 240 may be reduced as compared to when the user is sedentary (e.g. standing against a wall, or sitting on a seat in a public transport vehicle while commuting). Accordingly, power consumption may be reduced, and battery life of the display apparatus 400 may be extended.

In the embodiment shown in FIG. 5, when the identification result DR indicates that the user of the display apparatus 400 (e.g. a mobile phone) is walking, the display screen 240 may display the image output IM_{OUT} at a display resolution of 720P (1280×720); when the identification result DR indicates that the user of the display apparatus 400 is standing against a wall (i.e. an activity level of the user is low), the display screen 240 may display the image output IM_{OUT} at a display resolution of 1080P (1920×1080); when the identification result DR indicates that the user of the display apparatus 400 is sitting on a seat in a public transport vehicle while commuting (i.e. the user is in an almost still state), the display screen 240 may display the image output IM_{OUT} at a display resolution of 2K (2560×1440).

Please note that the display resolution values shown in FIG. 5 are for illustrative purposes only, and are not meant to be limitations of the present invention. Respective display resolution values corresponding to different user activities may be set according to different user requirements. In an alternative design, the user may set respective display resolution values corresponding to different types of user activities through the configuration UI 402. Additionally, image processing architecture (or display resolution adjustment architecture) of the proposed display apparatus is not limited to the image processing circuit 430 shown in FIG. 4. As long as image processing architecture may dynamically adjust a display resolution in response to a user activity, all modifications, equivalents, and alternatives fall within the spirit and scope of the present invention.

In addition to dynamically adjusting a display resolution in response to a user activity (or a type of user activity), the proposed display mechanism may further selectively activate dynamical resolution scaling according to a usage scenario. In one embodiment, the proposed display mechanism may not activate the dynamical resolution scaling in a still image output mode. Please refer to FIG. 4 again. In the embodiment shown in FIG. 4, the controller 220 may further determine whether the image output IM_{OUT} is a dynamic image signal (e.g. a video) or a still image signal (e.g. a picture). When the image output IM_{OUT} is the dynamic image signal, the controller 220 may refer to the identification result DR to determine the display resolution of the display screen 240; when the image output IM_{OUT} is the still image signal, the controller 220 may set the display resolution of the display screen 240 to a predefined value (i.e. the dynamical resolution scaling may not be activated). By way of example but not limitation, the controller 220 may refer to a frame update rate of the frame buffer 438 or check any update taken place over content of the frame buffer 438 to determine whether the image output IM_{OUT} is the dynamic image signal or the still image signal, wherein when the frame update rate is greater than a predetermined rate, the controller 220 may determine that the image output IM_{OUT} is the dynamic image signal.

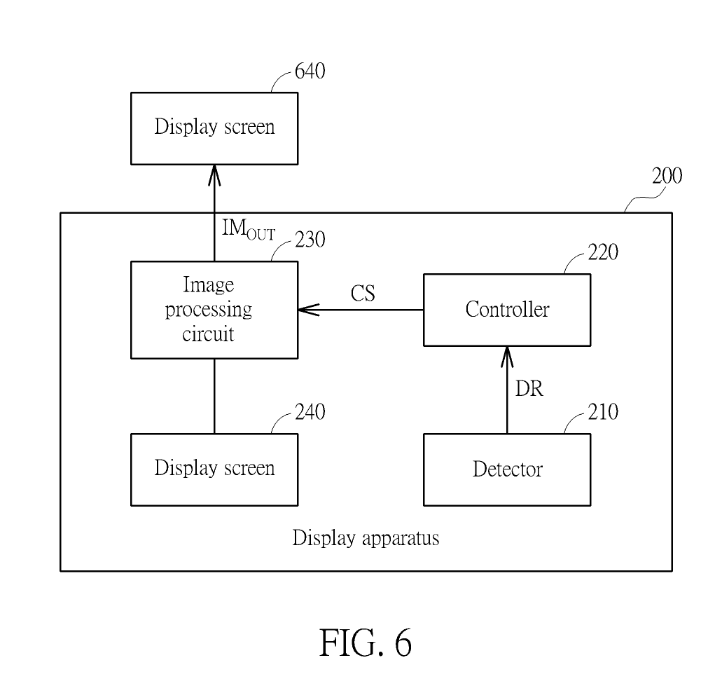

In another embodiment, the proposed display mechanism may not activate the dynamical resolution scaling in an external output mode. Please refer to FIG. 6, which is a diagram illustrating the display apparatus 200 shown in FIG. 2 connecting an external display screen according to an embodiment of the present invention. In this embodiment, the controller 220 may further determine whether the image processing circuit 230 transmits the image output IM_{OUT} to the display screen 640 externally connected to the display apparatus 200. When the image processing circuit 230 does not transmit the image output IM_{OUT} to the display screen 640 (as shown in FIG. 2), the controller 220 may refer to the identification result DR to determine the display resolution of the display screen 240; when the image processing circuit 230 transmits the image output IM_{OUT} to the display screen 640 (as shown in FIG. 6), the controller 220 may set the display resolution of the display screen 240 to a predefined value (i.e. the dynamical resolution scaling may not be activated).

In yet another embodiment, the proposed display mechanism may not activate the dynamical resolution scaling in a head mounted display mode. Please refer to FIG. 2 again. By way of example but not limitation, the display apparatus 200 may be implemented by a head-mounted display, or the display apparatus 200 (e.g. a mobile phone) may be inserted into a display holder to implement a head-mounted display. In this embodiment, the controller 220 may further determine whether the display apparatus 200 operates in a head mounted display mode, wherein when the display apparatus 200 does not operate in the head mounted display mode, the controller 220 may refer to the identification result DR to determine the display resolution of the display screen 240, and when the display apparatus 200 operates in the head mounted display mode, the controller 220 may set the display resolution of the display screen 240 to a predefined value (i.e. the dynamical resolution scaling may not be activated).

In still another embodiment, the user may input a selection signal through the configuration UI 402 to determine whether to activate the dynamical resolution scaling.

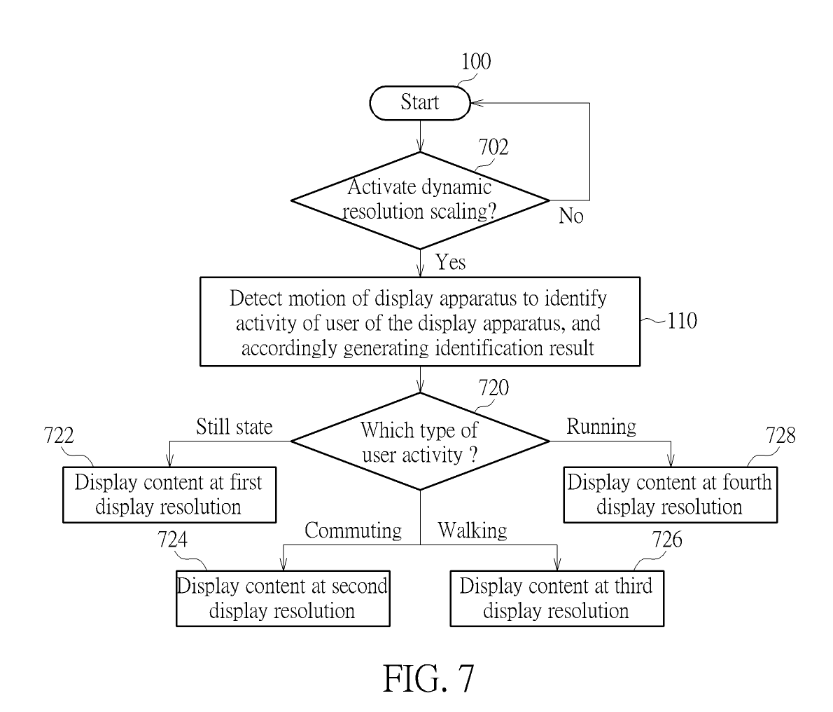

The display mechanism described above may be summarized in FIG. 7. FIG. 7 is a flow chart of an exemplary control method of a display apparatus according to an embodiment of the present invention. The control method shown in FIG. 7 is based on the control method shown in FIG. 1, wherein the main different is that the control method shown in FIG. 7 further include the step of determining whether to activate dynamical resolution scaling. For illustrative purposes, the control method shown in FIG. 7 is described with reference to the display apparatus 200 shown in FIG. 2. A person skilled in the art should understand that this is not meant to be a limitation of the present invention. In addition, provided that the result is substantially the same, the steps are not required to be executed in the exact order shown in FIG. 7. For example, steps can be added and/or omitted. The control method shown in FIG. 7 may be summarized below.

Step 100: Start.

Step 702: Determine whether to active dynamic resolution scaling. If yes, go to step 110; otherwise, return to step 110. For example, the controller 220 may determine whether the image output IM_{OUT} of the display apparatus 200 is a dynamic image signal or a still image signal. In another example, the controller 220 may determine if the display apparatus 200 output the image output IM_{OUT} to an external display screen (e.g. the display screen 640 shown in FIG. 6). In yet another example, the controller 220 may determine if the display apparatus 200 operates in a head mounted display mode.

Step 110: Detect motion of the display apparatus to identify an activity of a user of the display apparatus, and accordingly generate an identification result.

Step 720: Determine the activity of the user according to the identification result. If a type of the activity of the user is resting (e.g. the user is in a still state or resting in a chair), go to step 722; if the type of the activity of the user is commuting (e.g. the user is sitting on a seat in a public transport vehicle), go to step 724; if the type of the activity of the user is walking, go to step 726; if the type of the activity of the user is running, go to step 728.

Step 722: Display content (i.e. the image output IM_{OUT}) on the display screen 240 at a first resolution.

Step 724: Display content on the display screen 240 at a second resolution.

Step 726: Display content on the display screen 240 at a third resolution.

Step 728: Display content on the display screen 240 at a fourth resolution.

In one embodiment, step 120 shown in FIG. 1 may be implemented by steps 720-728. In another embodiment, the first resolution may be higher than the second resolution, the second resolution may be higher than the third resolution, and the third resolution may be higher than the fourth resolution. However, this is not meant to be a limitation of the present invention. Additionally, types of user activities are not limited to the aforementioned types. As long as a display resolution may be dynamically adjusted in response to a user activity, all modifications, equivalents, and alternatives fall within the spirit and scope of the present invention. As a person skilled in the art should understand the operation of each step shown in FIG. 7 after reading the above paragraphs directed to FIGS. 1-6, further description is omitted here for brevity.

To sum up, by dynamically adjusting a display resolution according to different user activities or usage scenarios, the proposed display mechanism may not only reduce power consumption but also maintain good user's viewing experience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display apparatus, comprising:
a detector, for detecting motion of the display apparatus to identify an activity of a user of the display apparatus, and accordingly generating an identification result; and
a controller, coupled to the detector, the controller arranged for determining a display resolution of the display apparatus according to the identification result.

2. The display apparatus of claim 1, wherein when the identification result indicates that the activity of the user is a first type user activity, the display resolution is a first resolution; and when the identification result indicates that the activity of the user is a second type user activity different from the first type user activity, the display resolution is a second resolution different from the first resolution.

3. The display apparatus of claim 1, further comprising:
an image processing circuit, coupled to the controller, the image processing circuit arranged for generating an image output according to the display resolution; and
a display screen, coupled to the image processing circuit, the display screen arranged for displaying the image output;
wherein the controller further determines whether the image output is a dynamic image signal or a still image signal; when the image output is the dynamic image signal, the controller refers to the identification result to determine the display resolution; and when the image output is the still image signal, the controller sets the display resolution to a predefined value.

4. The display apparatus of claim 3, wherein the image processing circuit comprises a frame buffer, and the controller refers to a frame update rate of the frame buffer to determine whether the image output is the dynamic image signal or the still image signal.

5. The display apparatus of claim 1, further comprising:
an image processing circuit, coupled to the controller, the image processing circuit arranged for generating an image output according to the display resolution;
wherein the controller further determines whether the image processing circuit transmits the image output to a display screen externally connected to the display apparatus; when the image processing circuit does not transmit the image output to the display screen, the controller refers to the identification result to determine the display resolution; and when the image processing circuit transmits the image output to the display screen, the controller sets the display resolution to a predefined value.

6. The display apparatus of claim 1, wherein the controller further determines whether the display apparatus operates in a head mounted display mode; when the display apparatus does not operate in the head mounted display mode, the controller refers to the identification result to determine the display resolution; and when the display apparatus operates in the head mounted display mode, the controller sets the display resolution to a predefined value.

7. The display apparatus of claim 1, wherein the detector comprises:
at least one acceleration sensor, for detecting the motion of the display apparatus to generate at least one sensor result; and
an activity determiner, coupled to the at least one acceleration sensor, the activity determiner arranged for identifying the activity of the user according to the at least one sensor result.

8. The display apparatus of claim 7, wherein the at least one acceleration sensor comprises at least one of a linear acceleration sensor and an angular acceleration sensor.

9. The display apparatus of claim 1, wherein a type of the activity of the user is resting, walking, running, cycling or commuting.

10. A control method of a display apparatus, comprising:
detecting motion of the display apparatus to identify an activity of a user of the display apparatus, and accordingly generating an identification result; and
determining a display resolution of the display apparatus according to the identification result.

11. The control method of claim 10, wherein when the identification result indicates that the activity of the user is a first type user activity, the display resolution is a first resolution; and when the identification result indicates that the activity of the user is a second type user activity different from the first type user activity, the display resolution is a second resolution different from the first resolution.

12. The control method of claim 10, wherein the display apparatus generates an image output according to the display resolution, and the control method further comprises:
determining whether the image output is a dynamic image signal or a still image signal;
wherein when the image output is the dynamic image signal, the step of determining the display resolution of the display apparatus according to the identification result is performed; and when the image output is the still image signal, the step of determining the display resolution of the display apparatus according to the identification result is not performed.

13. The control method of claim 12, wherein the step of determining whether the image output of the display apparatus is the dynamic image signal or the still image signal comprises:
referring to a frame update rate of the display apparatus to determine whether the image output is the dynamic image signal or the still image signal.

14. The control method of claim 10, wherein the display apparatus generates an image output according to the display resolution, and the control method further comprises:
determining whether the display apparatus transmits the image output to a display screen externally connected to the display apparatus;
wherein when the display apparatus does not transmit the image output to the display screen externally connected to the display apparatus, the step of determining the display resolution of the display apparatus according to the identification result is performed; and when the display apparatus transmits the image output to the display screen externally connected to the display apparatus, the step of determining the display resolution of the display apparatus according to the identification result is not performed.

15. The control method of claim 10, further comprising:
determining whether the display apparatus operates in a head mounted display mode;
wherein when the display apparatus does not operate in the head mounted display mode, the step of determining the display resolution of the display apparatus according to the identification result is performed; and when the display apparatus operates in the head mounted display mode, the step of determining the display resolution of the display apparatus according to the identification result is not performed.

16. The control method of claim 10, wherein the step of detecting motion of the display apparatus to identify an activity of a user of the display apparatus comprises:
detecting the motion of the display apparatus to generate at least one sensor result; and
identifying the activity of the user according to the at least one sensor result.

17. The control method of claim 16, wherein the at least one sensor result comprises at least one of a linear acceleration sensor result and an angular acceleration sensor result.

18. The control method of claim 10, wherein a type of the activity of the user is resting, walking, running, cycling or commuting.
